(19) United States
(12) Patent Application Publication
(10) Pub. No.: US 2003/0028430 A1
(43) Pub. Date: Feb. 6, 2003

(54) System, computer product and method for providing billboards with pull technology

(76) Inventor: Stephen M. Zimmerman, Cookstown (CA)

Correspondence Address: MILLER THOMPSON, LLP, 20 QUEEN STREET WEST, SUITE 2500, TORONTO, ON, M5H 3S1, CA

(21) Appl. No.: 10/083,586

(22) Filed: Feb. 27, 2002

Related U.S. Application Data
(60) Provisional application No. 60/308,847, filed on Aug. 1, 2001.

(51) Int. Cl. G06F 17/60; H04M 3/42

(52) U.S. Cl. 705/14; 455/414

(57) ABSTRACT

A billboard system for communicating marketing data to a plurality of individuals at least one display means adapted to display marketing information, the display device comprising a communication code interface for communicating at least one communication code corresponding to a marketing campaign to the plurality of individuals and a data delivery system associated with the at least one display means, the data delivery system comprising a memory for storing marketing data, including marketing data associated with the marketing information displayed by the display means and a communication means adapted to receive instructions from the plurality of users via a communication device, and to communicate data to the plurality of users via the communication device wherein the data delivery system is responsive to the communication device such that the communication means is adapted to permit the plurality of individuals to pull marketing data, including marketing data associated with the marketing information from the memory.

### FIELD OF THE INVENTION

This invention relates in general to systems, computer products and methods for providing billboard advertising with pull technology. This invention relates more particularly to a system, computer product and method for providing a billboard that is integrated with a communication system with pull technology capabilities whereby the billboard acts as a data gateway for targeted advertising.

### BACKGROUND OF THE INVENTION

Billboards are well known. They are routinely seen on the side of roads, highways, on vehicles, on buildings and so on. There are numerous existing billboard technologies. For example, posters, advertising screens combined with diffuser panels, light emitter diode (LED) screens, advertising screens combined with frame illumination and so on. Scrolling and rotating billboards are also known, wherein the advertising display portion of the billboard scrolls or rotates. This permits a single billboard to include multiple advertising images.

The positive subliminal marketing effect of such billboards is well documented and explains why numerous companies employ such advertising despite the significant costs. In some cities in North America, for example, the monthly cost related to the maintenance of multiple billboard campaigns is in the six-figure dollar range. It is generally well accepted that a significant amount of people pay attention to billboards.

However, once the attention of individuals is brought to the advertising message of a billboard, prior art billboards do not provide means for enhancing the marketing impact of such billboards using targeted advertising.

There is a need therefore for providing a system, computer product and method for delivering targeted advertising through a billboard. There is particular need for providing a system, computer product and method for delivering this targeted advertising on a cost efficient basis, using a system that is flexible.

### SUMMARY OF THE INVENTION

An object of one aspect of the present invention is to provide a billboard that is integrated with a communication system with pull technology capabilities whereby the billboard acts as a data gateway for targeted advertising.

### BRIEF DESCRIPTION OF THE DRAWINGS

A detailed description of the preferred embodiment(s) is(are) provided herein below by way of example only and with reference to the following drawings, in which:

FIG. 1 is a program resource flowchart illustrating the resources of the data delivery system of the present invention.

FIG. 2 is a program resource flowchart illustrating the resources of the data delivery system in a web implementation of the present invention.

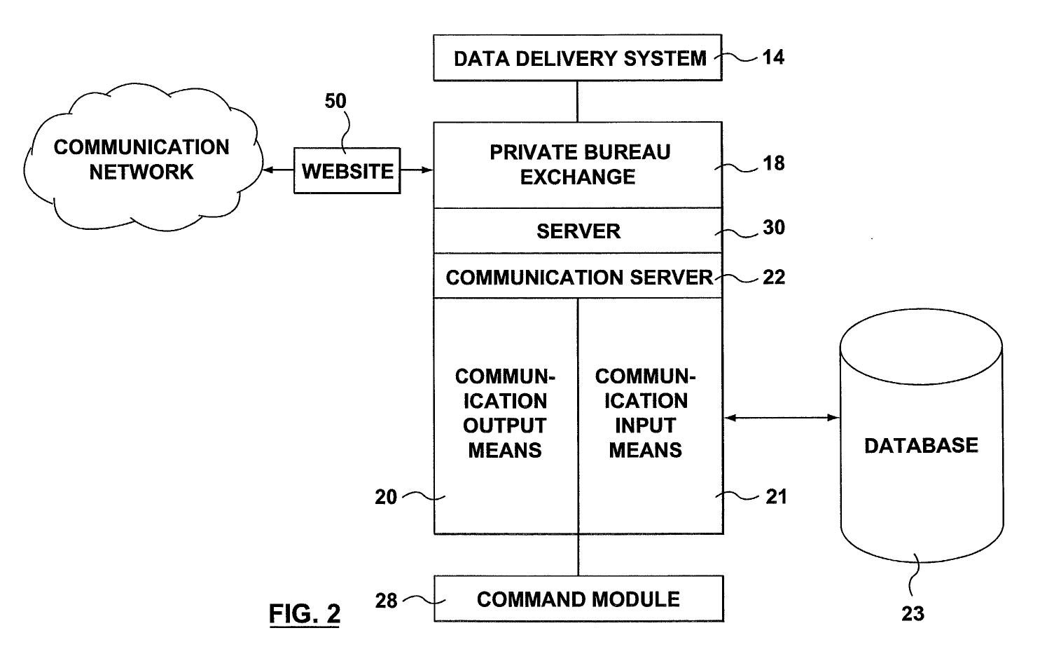

FIG. 3 is a program resource flowchart illustrating the resources of the data delivery system of the present invention further comprising a remote functionality.

In the drawings, preferred applications of the method of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

A known display means or billboard of a conventional construction (not shown) is provided. The billboard uses one or more technologies for delivering text and graphic content to a billboard as discussed above. Specifically, it is important to note that the billboard may comprise a print advertising or electronic advertising. The present invention also contemplates that billboard is an electronic billboard and comprises a digital graphic content delivery system such as an LED or digital screen, as well as a communication system for remotely managing the content displayed on such billboard as explained below.

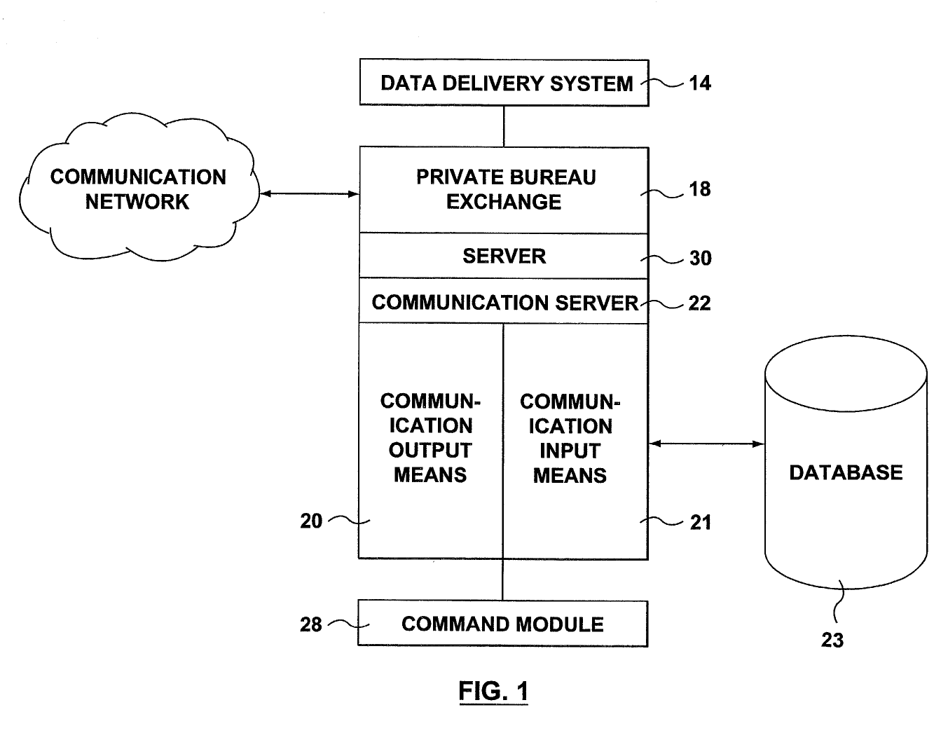

Whatever the content delivery system used by the billboard, the billboard of the present invention displays a communication code or communication tag such as a telephone number, telephone acronym, cellular network number (including an abbreviated number such as *88 or the like), and/or an URL. Individuals having viewed the billboard use the communication tag to access a data delivery system 14 that is accessible via the communication tag as best shown in FIG. 1.

A variety of communication devices are used by individuals to access the data delivery system 14, for example individuals may call a telephone number or abbreviated cell number by means of a cell phone, or on a land line at home, or may access the URL using a mobile browser on a cellular phone, two-way pager, wireless personal digital assistant or the like.

In the preferred embodiment of the data delivery system 14 described herein, the data delivery system 14 comprises a communication means (not shown) which utilizes known telephony hardware such as a Private Bureau Exchange 18 or “PBX” combined with fiber optic cabling by means of a series of ports, in a manner that is well known. The PBX 18 is capable of handling a large number of calls/communications.

The PBX 18 is connected to a data selection means or communication input means 21 which comprises means for processing requests made by an individual contacting the data delivery system 14. The communication input means 21 is best understood as a data access menu which permits requests to be received and processed. The content of each individual menu associated with a particular communication tag is tailored to the requirements of the particular entity or entities that have engaged the use of the billboard of the present invention. For example, in a telephone implementation of the data delivery system 14, the communication input means 21 comprises a touch tone menu provided in a manner that is well known. Further, in another implementation of the communication input means 21, said communication input means 21 comprises voice recognition capability, also in a manner that is well known.

The communication input means 21 permits the user to access various data and information including for example product or service pricing, specifications, promotions, features, contest information etc., in accordance with input received from the user. Accordingly, the data delivery system 14 permits a user to “pull” selected data or information from the data delivery system 14.

The PBX 18 is further connected with a communication output means 20 that is used to communicate information tailored to requests made by a caller to the PBX 18 by means of the communication input means 21. The communication output means 20 is operably connected to a communication server 22 capable of communication including by means of e-mail and faxes sent over, for example, known SMTP servers or fax boards 24 further connected to the PBX 18. Thereby communication output means 20 permits a user to engage communication output means 20 to forward data or information requested by a user in accordance with communication input means 21, for example, more detailed information on particular products or services of the advertiser who has engaged the use of the billboard.

It should be understood that the billboard also permits advertisers who have engaged the use of a billboard to broaden the marketing impact of an billboard. While prior art billboards are often product specific, the billboard of the present invention permits an billboard to promote a particular brand, whereas the data delivery system 14 is used to permit users to access information on particular products that form part of a broader umbrella brand. Therefore the billboard of the present invention is adapted to permit the extension of the marketing impact to a greater variety of products than conventional billboards permit.

Further connected to the PBX 18 is a software means (not shown) comprising a command module 28. The command module ;28 provides means for programming software means, in a manner that, is well, known, with settings defining a series of processing steps determining a particular processing cycle of PBX 18, as well as defining the data or information that can be accessed in association with a particular communication tag.

An example of a processing cycle is now illustrated. For example, in an billboard of the present invention that has been engaged by an auto manufacturer, a communication tag consisting of a telephone number is given. The advertising displayed by the billboard relates in this example to an automobile product. While the amount of information that can be displayed at the billboard may be limited because of the size thereof, the requirement that information be of a certain size in order to be visible, and also because too much information may distract drivers, a telephone number, in the present example, permits a driver (preferably in hands-free, voice recognition mode) to call the telephone number presented by the billboard using a cell phone and thereby to access the data delivery system 14. Alternatively, a person having viewed the billboard of the present invention may call the telephone number while walking by the billboard, or having made note of the telephone number, may call the billboard at a later time. A menu tailored to the automobile product (as discussed above) permits the driver to access, for example, information on price offerings on a particular model via the voice recognition capable menu provided by the data delivery system 14. The driver may also direct the data delivery system 14 to forward further information or direct marketing material to an postal address, email address or fax number by means of the same menu.

It should be understood that in accordance with the present invention, the billboard combined with the operation of data delivery system 14 of the present invention constitutes an advertising data gateway.

In the preferred embodiment of the data delivery system 14 of the present invention, PBX 18, communication server 22 and software means are connected to a server 30 with an operating system for hierarchical operation of the functions of the data delivery system 14. In the preferred embodiment of the data delivery system 14, the server 30 comprises a WINDOWS NT™ server, provided in a manner that is well known.

It should be further understood that the data delivery system 14 of the present invention also contemplates the processing of said requests by means of Internet including e-mails, hypertext documents, or wireless pager instructions, also in a manner that is well known.

The operation of data delivery system 14 of the present invention is best illustrated by way of example. Command module 28 is used to program software means so that when a particular communication is received by the data delivery system 14, such as a call to a particular telephone number or particular Internet request, or a sub-selection accessible at such telephone number or web address is selected, in a manner that is well known, one or more options is provided to a user. These options may be provided by a menu of items or other series of requests/commands, in a manner that is also well known.

The data delivery system 14 supplies, in this particular embodiment of the present invention, the phone number (or Internet identifier such IP address or “cookie”), time of call, date of call, duration of call (used to see how long they listen to a particular set of messages), the extension accessed (each piece of information or ad will have a unique extension number the caller must enter to access the recorded information), and the source of the call (for example, the caller must key in “1” if calling from a newspaper, “2” if calling from a “Flyer”, “3” if they are calling from the billboard in the case of a multiple medium advertising program, in which the billboard is one medium). The data delivery system 14 may obtain (in predetermined circumstances) the name, address or other contact data of the caller. The system of the present invention also permits authorized users thereof to generate a “call report” based on the name, address or other contact data of a caller having contacted the date delivery system 14, as well as the parameters of such communication, including duration of communication, selections of the user from the menu, and so on. Then, the data or information requested such as a “free offer” or product specifications will be transmitted to the caller by means of the contact data and communication server 22, for example, by faxing the information requested to the number or email address given by the caller.

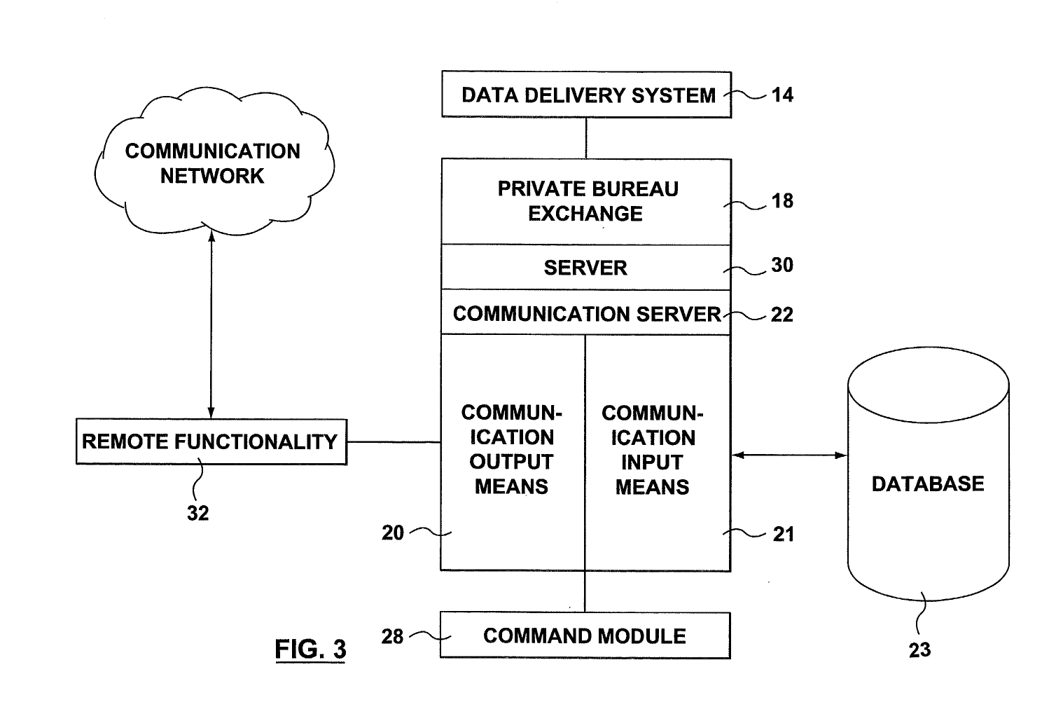

It should also be understood, that the data delivery system 14 provides remote functionality 32 that permits clients of the operator of the data delivery system 14 to remotely distribute sound, video, text, information or other material through the communication system 16, and also to permit controlled changes to software means and therefore a particular processing cycle to which the clients have subscribed. This feature is provided in a manner that is well known by the remote content control means of the present invention. In particular a system of limited and hierarchical access is employed wherein a particular user of a customer of the operator of the data delivery system 14 is provided with access to remote functionality 32, in accordance with parameters set by access privileges defined for such particular user. For example, the present invention permits distribution of a particular ad accessible through the data delivery system 14 by contacting same and uploading specific data or information. Advertisements or other material distributed using the data delivery system 14 can be modified or replaced using the remote functionality 32. It should be also understood that remote functionality 32 can be provided to communicate with the communication network, as best shown in FIG. 3, so as to permit authorized users of a customer of the operator to modify content of the billboard remotely where billboard is an electronic billboard, in a manner that is well known.

The data collected by the data delivery system 14 from a user is provided to database 23 (for example data regarding the specific information accessed by a particular user by means of the data delivery system 14). This data can be analyzed in a manner that is well known. The entity or entities engaging use of the billboard may then in response to such data modify the data, information or options provided by the data delivery system 14 in relation to a particular communication tag, for example by means of remote functionality 32.

It should also be understood that the method described above provides the opportunity for various sellers to share the costs of advertising and direct marketing including: the cost of engaging use of the billboard; the cost of maintaining the communication network; the cost of producing and/or delivering the direct marketing material; and the cost of any additional incentives such as contest prizes.

The system of the present invention is best understood as a data delivery system 14 that is associated with a billboard, as described herein, and adapted to communicate with a plurality of users by means of a communication tag. The computer product of the present invention is best understood as a software program resident on the data delivery system 14 that permits predetermined menus, data and information to be offered, corresponding to a communication tag, and which data and information can be “pulled” by a plurality of users. The method of the present invention consists of providing the system of the present invention, receiving communication from a plurality of users using a communication tag, the plurality of users accessing menus, data and information in regard to a communication tag, and plurality of users forwarding further data and information to phone number, postal address, email address or fax number in response to input received from the plurality of users.

In a second preferred embodiment of the present invention, the data delivery system 14 is integrated with an interconnected network of computers such as the Internet. In this second preferred embodiment, the communication tag is an URL corresponding to a web site 50 that is associated with billboard, or the promotion to which billboard relates. Web site 50 is accessible via mobile browsers on cell phones, two-way pagers, personal digital assistants, personal computer and the like. The menu, and data and information related to the billboard or promotion, discussed above, as well as related video, audio content etc. is accessible via web site 50. Specifically, data delivery system 14 and web site 50 is provided in a manner that is known wherein clicking on specific items on web site 50 such as text/graphic listings of options launches audio recordings retrieved from data delivery system 14 in a manner that is well known. Web site 50 also provides means for “pulling” data such as information regarding “free offers”, specifications on specific products and the like.

In a third preferred embodiment of the present invention, the billboard system is connected to a known e-commerce facility which permits the purchase of goods or services associated with the billboard system, as described above, via the Internet, in a manner that is well known.

Other variations and modifications of the invention are possible. For example, the examples of operation of the data delivery system 14 provided focused on voice applications. It should be understood that the menus, and data and information accessed and forwarded via, provided by it can be provided in other media. It should also be understood that additional features and or interfaces with other forms of communication can be provided to communication server 22. All such modifications or variations are believed to be within the sphere and scope of the invention as defined by the claims appended hereto.

I claim:

1) A billboard system for communicating marketing data to a plurality of individuals:
a) at least one display means adapted to display marketing information, the display device comprising a communication code interface for communicating at least one communication code corresponding to a marketing campaign to the plurality of individuals; and
b) a data delivery system associated with the at least one display means, the data delivery system comprising:
i) a memory for storing marketing data, including marketing data associated with the marketing information displayed by the display means; and
ii) a communication means adapted to receive instructions from the plurality of users via a communication device, and to communicate data to the plurality of users via the communication device
wherein the data delivery system is responsive to the communication device such that the communication means is adapted to permit the plurality of individuals to pull marketing data, including marketing data associated with the marketing information from the memory.

2) A billboard system as claimed in claim 1, wherein the data delivery system comprises a data selection means adapted to process instructions communicated to the communication means by the plurality of individuals via the communication device for selection of specific marketing data from the memory, and communication of the specific marketing data to the plurality of individuals.

3) A billboard system as claimed in claim 2, wherein the data selection means is adapted to process instructions to communicate the specific marketing data to the communication device.

4) A billboard system as claimed in claim 3, wherein the data selection means is responsive to the communication device providing the communication code as an input to the communication means.

5) A billboard system as claimed in claim 4, wherein the data selection means is further adapted to process instructions from the communication device to forward specific marketing data to a location other than the communication device.

6) A billboard system as claimed in claim 5, wherein the data selection means comprises a data access menu for selecting specific marketing data, including marketing data associated with the marketing information from the memory.

7) A billboard system as claimed in claim 6, wherein the communication means further comprises a remote content control means, wherein said remote content control means is adapted to permit customers of the billboard system to update the marketing data stored in the memory.

8) A billboard system as claimed in claim 7, wherein said remote content control means is further adapted to permit customers of the billboard system to remotely alter the content of the data access menu.

9) A billboard system as claimed in claim 8, wherein said remote content control means further provides means for remotely altering the content of the marketing information displayed by the display means.

10) A billboard system as claimed in claim 6, wherein the communication code is a phone number, and the data selection means is responsive to key input or voice commands received from the communication device.

11) A billboard system as claimed in claim 6, wherein the communication device is a web enabled device, and the communication code is an URL, and the communication means is connected to the Internet, such that the input of the URL to the web enabled device provides access to the data selection means.

12) A billboard system as claimed in claim 10, wherein the communication device comprises a telephone or wireless phone.

13) A billboard system as claimed in claim 11, wherein the communication device comprises a land line telephone, personal digital assistant, 2-way wireless pager, or WAP enabled wireless phone.

14) A billboard system as claimed in claim 10, wherein the marketing information comprises text, graphic, video, audio or multimedia marketing data.

15) A billboard system as claimed in claim 14, wherein the marketing data stored to the memory comprises product or service offering details and product or service promotions.

16) A billboard system as claimed in claim 15, wherein the display means is a video billboard system comprising at least one screen defining an image area comprising the marketing information and adapted to illuminate the image area.

17) A billboard system as claimed in claim 16, wherein the display means further comprises a receiver adapted to receive commands from the remote content control means for controlling the images illuminated by the video billboard system.

18) A billboard system as claimed in claim 17, wherein the display means is adapted to receive commands from customers of the billboard system via the remote content control means for controlling the images illuminated by the video billboard system.

19) A billboard system as claimed in claim 18, wherein said video billboard system comprises an advertising screen combined with at least one diffuser panel, an LED screen or a plasma screen.

20) A system for delivering targeted marketing data in association with at least one advertising display mean, said system comprising a computer, said computer comprising:
a) a memory for storing said targeted marketing data;
b) a communication means associated with the computer, wherein said communication means is adapted to permit communication between said computer and at least one communication device corresponding to at least one individual; and
c) a data selection means connected to said communication means, adapted to process instructions received by said communication means from said communication device so as to permit said at least one individual to select and access targeted marketing data from said memory.

21) A system for delivering targeted marketing data as claimed in claim 20, wherein said communication means comprises a private bureau exchange.

22) A computer product for facilitating the delivery of targeted marketing data in association with a data delivery system connected to at least one advertising display means comprising:
a) a recording means;
b) means recorded on said recording means for providing instructions to the data delivery system, wherein the data delivery system is adapted to provide:
i) a memory for storing marketing data, including marketing data associated with the marketing information displayed by the display means; and
ii) a communication means adapted to receive instructions from the plurality of users via a communication device, and to communicate data to the plurality of users via the communication device
wherein the data delivery system is responsive to the communication device such that the communication means is adapted to permit the plurality of individuals to pull marketing data, including marketing data associated with the marketing information from the memory.

23) A method of delivering targeted marketing data to a plurality of individuals comprising the steps of:
a) providing at least one display means adapted to display marketing information and comprising a communication code interface for communicating at least one communication code corresponding to a marketing campaign to the plurality of individuals;
b) providing a data delivery system associated with the display means, the data delivery system comprising:
i) a memory for storing marketing data, including marketing data associated with the marketing information displayed by the display means; and
ii) a communication means adapted to receive instructions from the plurality of users via a communication device, and to communicate data to the plurality of users via the communication device
wherein the data delivery system is responsive to the communication device such that the communication means is adapted to permit the plurality of individuals to pull marketing data, including marketing data associated with the marketing information from the memory; and
c) providing communication between the data delivery system and the communication device to receive instructions from the communication device, thereby permitting the plurality of individuals to pull specific marketing data selected by the plurality of individuals from the memory.
